(19) United States
(12) Patent Application Publication
(10) Pub. No.: US 2008/0288481 A1
(43) Pub. Date: Nov. 20, 2008

(54) Ranking online advertisement using product and seller reputation

(75) Inventors: Huajun Zeng, Beijing (CN); Chenxi Lin, Beijing (CN); Dingyi Han, Beijing (CN); Benyu Zhang, Beijing (CN); Zheng Chen, Beijing (CN); Jian Wang, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/803,462

(22) Filed: May 15, 2007

(51) Int. Cl. G06F 17/30

(52) U.S. Cl. 707/5; 707/E17.014

(57) ABSTRACT

Described is a technology by which online advertisements for returning with a query response are ranked according to reputation. The reputation may correspond to a product or service and/or seller reputation. In one example, a set of relevant advertisement items are located and ranked using reputation data as a factor. For example, for each item, a ranking value is based on a mathematical combination of a product reputation score, a seller reputation score and a relevance score, with the items ranked by their computed values. The scores may be weighted differently. The reputation data may be mined from a review source, such as customer reviews available on the web. In one example implementation, a 3-gram model that considers terms in the review along with the two terms proceeding each term is used to analyze the reviews to determine whether each review is positive or negative with respect to the reputation.

### BACKGROUND

Advertisement search, or “ads” search, is a popular web technique that helps websites gain profits from free search and other online services. For example, search engines like MSN Search operate online advertising businesses within their search result pages. In general, advertisers pay the search engines for user clicks, whereby the more clicks that occur (that is, the greater the conversion rate of users' clicks on advertisements), the more profit that is made.

Typically, advertisements are ranked by automatic ranking algorithms similar to those used in web query searching, which generally calculate the similarities between advertisement content and user queries, search results, each advertiser's per-click payment amount, and so forth. However, heretofore such ranking algorithms have not recognized the characteristics of the advertisements themselves, and any mechanism that improves the user click rate on advertisements would be commercially valuable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which items corresponding to online advertisements that are to be returned with a query response are ranked using reputation data. The reputation may correspond to a reputation of a product or service and/or a seller (e.g., retailer or wholesaler, or service provider).

In one implementation, advertisement items are previously processed based on relevance, which may include relevance to the search terms and/or advertiser payment. A reputation ranking mechanism ranks (or re-ranks) the advertisement items using reputation data as a factor in the ranking. For example, for each item of information corresponding to an advertisement, the ranking mechanism determines a value based on a mathematical combination of a product reputation score, a seller reputation score and a relevance score, and ranks the items according to the values. The scores may be weighted differently relative to one another in the mathematical combination.

The product (or service) and/or seller reputation data may be mined from a review source, such as customer reviews available on the web. In one example implementation, a model is used to analyze the text of the reviews to determine whether each review is more likely positive or more likely negative with respect to the reputation. One such model is a 3-gram model that considers terms in the text along with the two terms proceeding each term.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1A is a block diagram representing an example system for processing a query to rank advertisements provided as part of the response thereto based on reputation data.

FIG. 1B is a block diagram representing an alternative example system for processing a query to rank advertisements provided as part of the response thereto based on reputation data.

FIG. 2 is a flow diagram representing example steps taken to rank advertisements based on reputation data.

FIG. 3 is a block diagram representing an example architecture for determining reputation of a product (or seller) based on mining data corresponding to reviews of that product.

FIG. 4 is a flow diagram representing example steps for determining reputation of a product (or seller) based on mining data corresponding to reviews of that product.

FIG. 5 shows an illustrative example of a general-purpose network computing environment into which various aspects of the present invention may be incorporated.

### DETAILED DESCRIPTION

Various aspects of the technology described herein are generally directed towards a ranking mechanism that in part uses reputation data to select and/or rank which advertisements (e.g., a link comprising an image and/or text) to provide to users in conjunction with a query response. In general, because consumers tend to be more interested in reputable products, services and/or suppliers, the ranking mechanism described herein ordinarily increases the overall user click rate (and thus profits) generated from online advertising. Indeed, reputation may be one of the most important factors for a user that is deciding whether to click on an advertisement. Notwithstanding, as can be readily appreciated, the various aspects of the ranking mechanism are independent of any particular business or revenue model. For example, the use of reputation data in selecting and/or ranking any set of data may benefit from the aspects described herein.

Further, while as described herein the term “reputation” generally includes concepts such as user opinions about advertised products or services and/or the advertisers (e.g., retailers, wholesalers or service providers) providing the products or services, there is no requirement as to any particular source of reputation data. For example, the general public's overall reviews may be one source, a professional reviewing enterprise (or the like) an alternative or additional source, a limited group of individuals or the like (e.g., only reviewers that fit a certain demographic) yet another possible source, and so forth. Moreover, as used herein, the terms “product” and “service” are interchangeable, such as in the various examples, for purposes of simplicity.

As such, the present invention is not limited to any particular embodiments, aspects, concepts, protocols, formats, structures, functionalities or examples described herein. Rather, any of the embodiments, aspects, concepts, protocols, formats, structures, functionalities or examples described herein are non-limiting, and the present invention may be used various ways that provide benefits and advantages in computing and information retrieval technology in general.

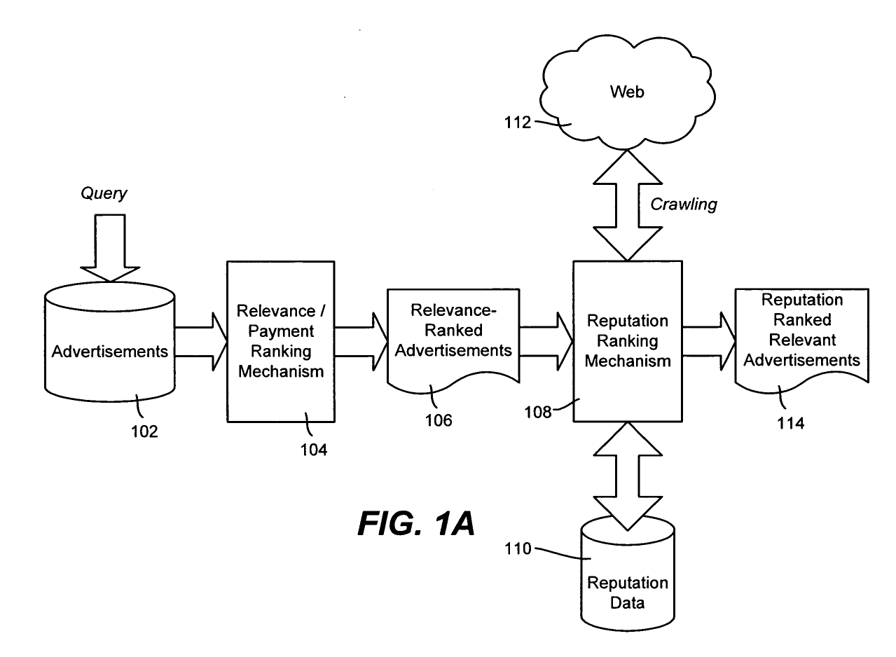

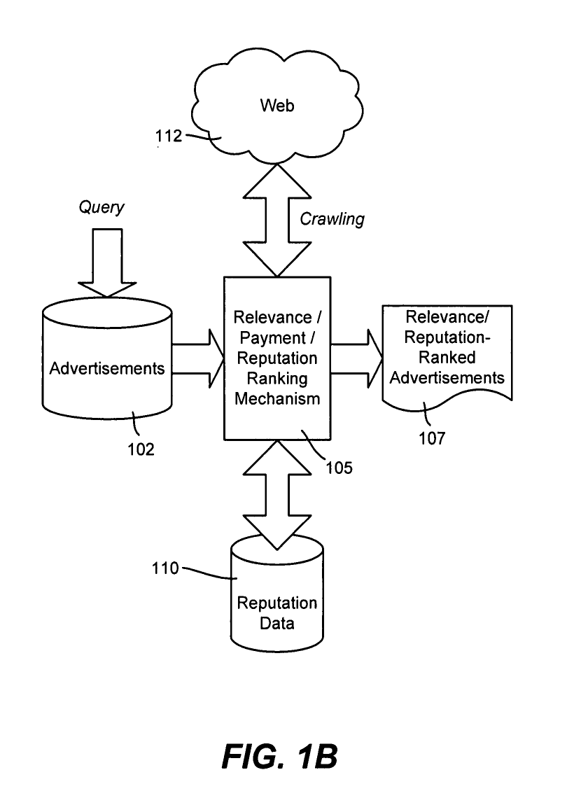

Turning to FIG. 1A, there is shown a data store of advertisements 102, which any suitable relevance ranking mechanism 104 may search when given a query to obtain a set of advertisements 106 ranked by relevance as well as typically the per-click payment amounts by the advertisers. An example of one such relevance ranking mechanism 104 is described in copending United States patent application entitled “Efficient Retrieval Algorithm by Query Term Discrimination,” assigned to the assignee of the present invention and hereby incorporated by reference. Note that the set of relevance ranked advertisements 106 may be some limited number, such as a fixed number and/or only those meeting a threshold relevance score. However, how advertisements in a given implementation may be chosen and ranked are determined by an online advertising company strategy; e.g., there may be various factors considered, including relevance, click-through rate, geographical position, and so forth.

As described herein, a reputation ranking (or re-ranking) mechanism 108 processes the relevance-ranked set of advertisements 106, using reputation data 110 and/or the web 112 as part of the criteria to determine a set of reputation ranked relevant advertisements 114. Note that the reputation ranking mechanism 108 of FIG. 1A is shown as processing the already-ranked advertisements 106, however it is feasible to incorporate the reputation mechanism into a relevance-ranking mechanism, such as including a pre-computed reputation score in an inverted query index or the like that is used to search for relevant advertisements based on the query's search terms.

FIG. 1B shows such an alternative with a relevance/payment/reputation ranking mechanism 105 that generates a single ranked output set 107, where like numbers represent like components. Thus, as used herein, “ranking” by reputation includes ranking as part of an original ranking process (e.g., in conjunction with a relevance and/or payment ranking process), as a pre-ranking process (e.g., before ranking by a relevance and/or payment ranking process), or re-ranking (e.g., following a relevance and/or payment ranking process as exemplified in FIG. 1A).

As represented in FIGS. 1A and 1B, the reputation ranking mechanism 108 (FIG. 1A) or mechanism 105 (FIG. 1B) is shown as dynamically crawling the web 112 and/or using cached reputation data 110. In an alternative implementation, another mechanism may regularly obtain at least some of the reputation data and cache it independent of the query processing, such as an offline mechanism that regularly updates the reputation data store 110.

To automatically rank advertisements by product (equivalent to service) reputation considerations, the technology described herein uses one or more various factors with respect to traditional content relevance ranking algorithms. Such factors include the reputation of products and/or services, and/or the reputation of sellers (e.g., retailers, wholesalers, service providers and the like). As described below, the reputation data may be predicted by mining reviews and the like that are available from various sources, such as online customer reviews.

For example, surveying product and other information before making an online transaction is a fairly popular consumer trend. Various product information portals usually provide product specifications, seller prices and customer reviews. Many users use such portals to compare specifications of similar products, to choose a particular seller based on price, to review others' comments to learn about their consumer experiences, and so forth. However, the number of products and sellers is very large, making it difficult and time-consuming for consumers to collect the necessary information.

To this end, an automatic prediction mechanism (e.g., incorporated into the reputation ranking mechanism 108) predicts product/seller reputations by mining customer reviews, such as those that are published on product information portals. The reputation data is represented as the positive review percentage, which in one example implementation is formalized as set forth herein.

More particularly, consider that the collected review set of a give product p is S(p)={r₁, r₂, . . . rₙ}. For each review r, the reputation R(r) can be either positive (POS) or negative (NEG). Typically, a review r is regarded as a series of terms, r=w₁w₂ . . . wₖ, where w represents a word; (however as used herein, the concept of a “term” includes any single entity that can be represented in a data structure, such as a word, symbol, shape and so forth, and/or any phrase comprising a plurality of such entities.) For example, “good,” “bad,” “excellent,” “defective,” and so forth are all terms that may be associated with a product review. As described below, a reputation value R(r) is made by analyzing the term series using a 3-gram model (described below) so that terms such as “no good” or “not very good” will not be misinterpreted as good.

Thus, given a query, one example implementation described herein ranks advertisements by considering each advertisement's relevance to the query and/or the payment of advertisers, as well as by analyzing reviews and the like with respect to the sellers and/or the products or services. In the example implementation, three general steps are performed, including collecting the reviews (or like data, which will be considered a “review” herein), classifying review opinions, and then using the review information to rank advertisements (or re-rank candidate advertisements previously ranked based on relevance and/or payment considerations).

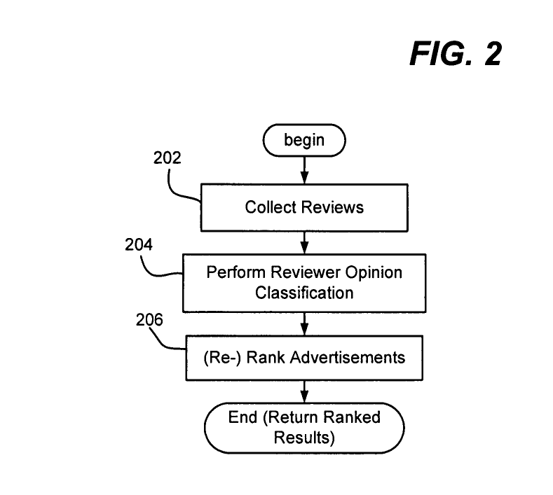

To collect reviews as generally represented via step 202 of FIG. 2, various web sites that contain reviews may be crawled. Additional sources of reviews, such as databases, reviewing enterprises, and so forth may likewise be accessed.

As represented by step 204, reviewer opinion classification is next performed, which classifies reviews into positive ones and negative ones. The result is a positive review percentage of each product and seller. Note that the number of reviews can also be counted, because not all of the reviews have a rating value or the like, and the reviews from different web sites usually have different rating mechanisms. For example, there may be ten ratings at xyz.com, while there are only five ratings at abcd.com.

In this example, a-last step is to rank the advertisements, including ranking based on reputation data. For example, with the seller and product information provided by the advertisers, the relation between an advertisement and reviews can be easily established. The ranking mechanism generally analyzes the reviews' text and calculates the reputation, in terms of whether the reviews are positive or negative. For example, for a given query (q), a set of relevant advertisements 106 may be ranked (or re-ranked) into the reputation based set 114 by the following scoring function for each advertisement (ad):

Score(ad,q)=αRₚ(Review_{Seller}(ad))+βRₚ(Review_{Product}(ad))+θRelevance(ad, q)

where α+β+θ=1.

As can be seen, the example scoring function above takes three factors into consideration, namely Rₚ(Review_{Seller}(ad)), which represents the positive rate of the comments to the associated seller, Rₚ(Review_{Product}(ad)), which represents the positive rate of the comments to the associated product (or service), and Relevance(ad, q), which represents the relevance between the advertisement (ad) and the query q. Weighting each factor may be accomplished via the variables α, β and θ.

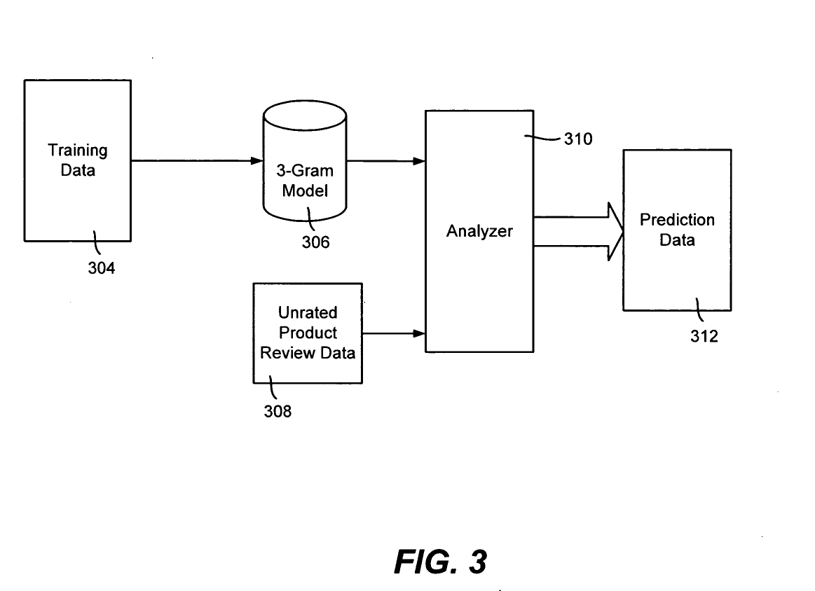

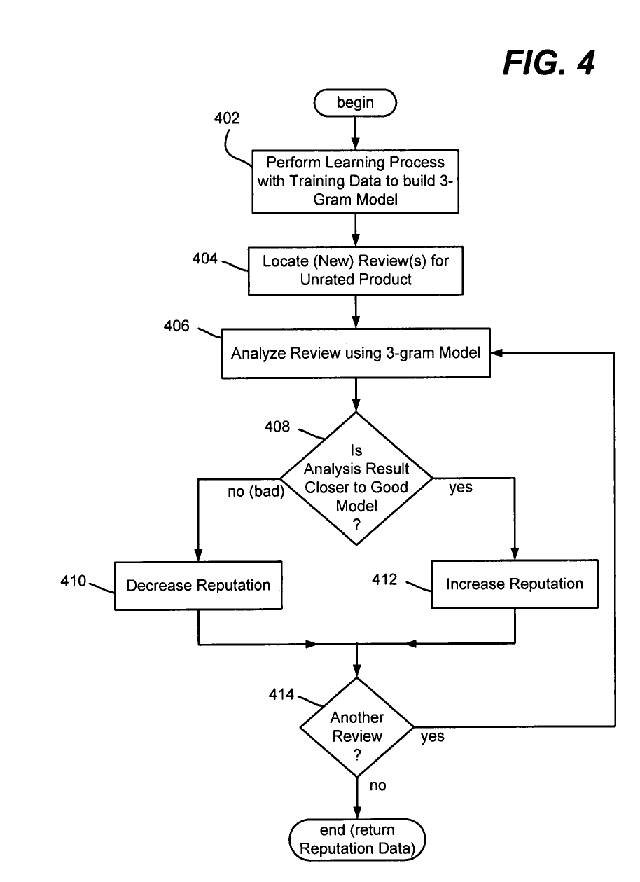

Turning to a consideration of mining reviews to predict product reputation, in one implementation, a 3-gram statistical approach is used. With respect to mining reviews, an online product information portal for example, is one valuable information resource that typically provides product specifications, seller price information and user comments. This information explicitly or implicitly correlates to the product reputation and quality. As can be readily appreciated, note that comments/reviews on sellers may be similarly processed, but for purposes of simplicity, FIGS. 3 and 4 will refer to product reviews, analysis and reputation results.

FIG. 3 represents an example architecture that automatically predicts product reputation. To this end, a 3-gram model 304 is built from training data 306 comprising some number of reviewer comments crawled from Web. The training data 304 can then be analyzed (e.g., manually) to build the 3-gram model 306 whereby it is known to be highly accurate with respect to what reviewers think of the product reputation and quality. (Note that seller reputation may be similarly used as training data for a 3-gram model.) Step 402 of the flow diagram of FIG. 4 represents this learning/training step, which may be repeated as often as desired as new training data becomes available.

After the 3-gram model is built, given a review 308 or like data of an unrated product, an analyzer 310 then analyzes the text of the user review data (e.g., comments) for that unrated product using the 3-gram model 306. Note that the web may be crawled regarding comments on that product on demand as needed for a query, or in advance, such as in an offline reputation store building state. Step 404 locates finding one or more reviews for the product.

Step 406 represents the analysis against the 3-gram model to locate series of terms that determine (step 408) whether the review is more like the positive model or the negative model. Note that the review can be discarded or otherwise handled if, for example, the text is corrupted or otherwise nonsensical. Step 410 or 412 decreases or increases that product's reputation, respectively, as set forth above (e.g., via its positive review percentage).

in one example implementation, the 3-gram statistical approach of mining customer reviews assumes that a term (e.g., “good” or “bad”) within a reviewer's comments is related to the former two terms (e.g., “not” or “not so”), as set forth below:

P(ω₁ω₂ω₃)=P(ω₃|ω₁ω₂)=#(ω₁ω₂ω₃)/#(ω₁ω₂)

where #(w) is the frequency of term series w. The learning process is used with training data 304 (step 402) to learn the 3-gram language model of both positive and negative comments. Both the positive comment model Mₚ and the negative comment model Mₙ comprise a set of term series representing their probabilities in the training set.

In one example implementation, to predict a comment c=w₁ w₂ w₃ . . . wₖ to be positive or negative, a decision is made as to which model a comment is more alike. Given m* as the model:

$$\begin{matrix}{m}^{*} = arg {max}_{i ∈ \{ p , n \}} P ( {M}_{i} \vert c ) \\ = arg {max}_{i ∈ \{ p , n \}} \frac{P ( {M}_{i} ) P ( c \vert {M}_{i} )}{P ( c )} \\ = arg {max}_{i ∈ \{ p , n \}} P ( {M}_{i} ) P ( {ω}_{1} {ω}_{2} {ω}_{3} ⋯ {ω}_{k} \vert {M}_{i} ) \\ = arg {max}_{i ∈ \{ p , n \}} P ( {M}_{i} ) P ( {ω}_{1} {ω}_{2} {ω}_{3} ⋯ {ω}_{k} ) \\ = arg {max}_{i ∈ \{ p , n \}} P ( {M}_{i} ) {\prod }_{j = 3}^{k} P ( {ω}_{k - 2} {ω}_{k - 1} {ω}_{k} )\end{matrix}$$

Any number of new (that is, not already processed) reviews may be analyzed, as represented via step 414. The result is a prediction as to the product's reputation, shown in FIG. 3 as that product's prediction data 312. Via step 414, the prediction data 312 can be mathematically combined from any number of user reviews. Note that while FIGS. 3 and 4 refer to an “unrated” product, it is understood that an already rated product may be reanalyzed any number of times, such as to keep the reputation rating relatively updated, and/or reanalyzed on demand. Further, note that other reviews (e.g., step 404) may be located by crawling while the analysis and processing of located reviews (steps 406, 408 and 410 or 412) are taking place (e.g., in parallel).

In this manner, the reputation of a product and/or seller may be used as factors in determining a ranking order of advertisements to provide as part of the response to a user query. In conjunction with relevance, the click-rate on advertisements will increase.

### Exemplary Operating Environment

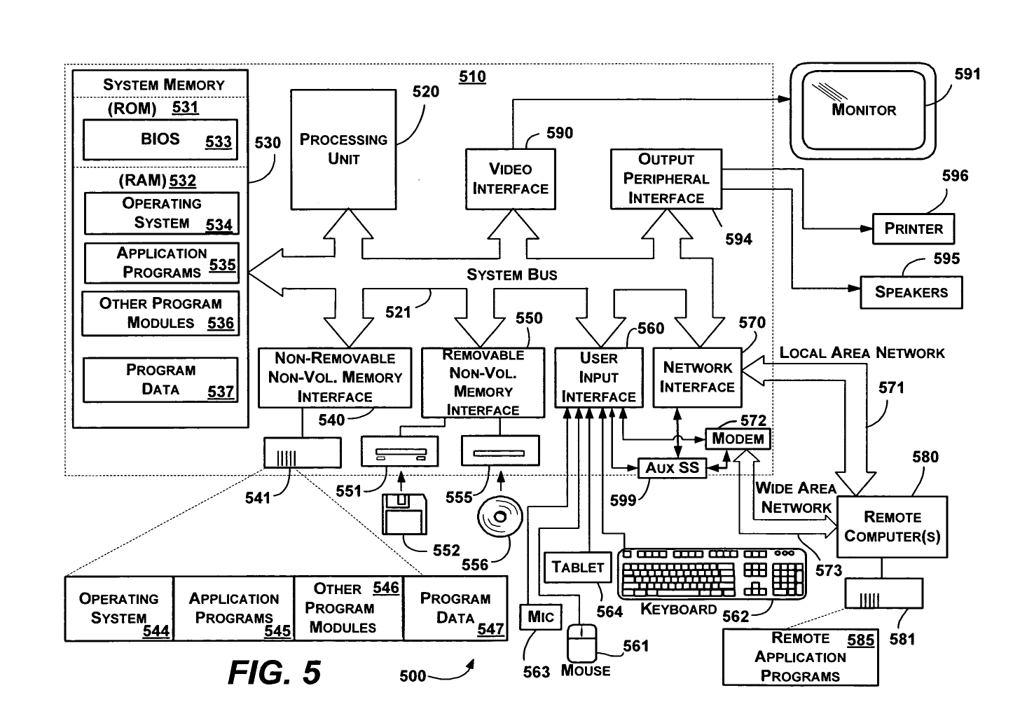

FIG. 5 illustrates an example of a suitable computing system environment 500 on which the examples represented in FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising:
processing a query;
ranking a set of information comprising a plurality of query-relevant content corresponding to advertisements based on product or service reputation or seller reputation, or a combination of product or service reputation and seller reputation; and
providing at least part of the set as ranked advertisement data based on the ranking, for including in a response to the query.

2. The method of claim 1 wherein processing the query includes performing a relevance ranking to obtain the set of information.

3. The method of claim 2 wherein the relevance ranking includes an advertiser payment factor.

4. The method of claim 1 wherein raking the set of information comprises, for each item of information corresponding to an advertisement, determining a value based on a mathematical combination of a product or service reputation score, a seller reputation score and a relevance score.

5. The method of claim 4 wherein at least two of the scores are weighted differently relative to one another in the mathematical combination.

6. The method of claim 1 further comprising, determining the product or service reputation based on data mined from a review source.

7. The method of claim 6 wherein the data mined from the review source comprises a product or service review, and wherein determining the product or service reputation comprises analyzing text of the product or service review using a model in which a series of terms in the product or service review are analyzed against data in the model to determine whether the review is more likely positive or more likely negative with respect to the product or service reputation.

8. The method of claim 7 wherein the model comprises a 3-gram model, and wherein analyzing the text comprises considering a term and two terms proceeding that term.

9. The method of claim 1 further comprising, determining the seller reputation based on mining data from a review source.

10. The method of claim 9 wherein the data mined from the review source comprises a seller review, and wherein determining the seller reputation comprises analyzing text of the seller review using a model in which a series of terms in the seller,review are analyzed against data in the model to determine whether the review is more likely positive or more likely negative with respect to the seller reputation.

11. The method of claim 10 wherein the model comprises a 3-gram model, and wherein analyzing the text comprises considering a term and two terms proceeding that term.

12. In a computing environment, a system comprising:
means for receiving a query and locating items of data corresponding to advertisements for product or services relevant to that query;
a reputation ranking mechanism that ranks the items of data based on product or service reputation or seller reputation, or a combination of product or service reputation and seller reputation; and
means for providing the items of data for returning as corresponding reputation-ranked advertisement data included in a response to the query.

13. The system of claim 12 wherein the means for receiving the query and locating the items of data includes a relevance ranking mechanism, a payment ranking mechanism, or a combination of a relevance ranking mechanism and a payment ranking mechanism.

14. The system of claim 12 wherein the reputation ranking mechanism is coupled to a source of reputation data.

15. The system of claim 14 wherein the source of reputation data comprises web-available reviews, or a source of reputation data corresponding to web-available reviews, or a combination of web-available reviews and a source of reputation data corresponding to web-available reviews.

16. The system of claim 15 further comprising an analyzer that analyzes text within the web-available reviews using a model to predict whether a review is positive or negative.

17. The system of claim 16 wherein the model comprises a 3-gram model that considers a term and two terms preceding that term.

18. A computer-readable medium having computer-executable instructions, comprising:
accessing a set of data items, each data item corresponding to an advertisement; and
ranking at least part of the set of data items based on a combination of reputation data and relevance to a query or advertiser payment, or a combination of reputation data and both relevance to a query and advertiser payment.

19. The computer-readable medium of claim 18 wherein ranking the data items includes determining a value based for each item based on a mathematical combination of a product or service reputation score, a seller reputation score and a relevance score, and re-ranking according to the score determined for each item.

20. The computer-readable medium of claim 18 wherein the reputation data is determined from web-available reviews by analyzing text in the reviews using a 3-gram model that considers terms and two terms preceding each of those terms in the text.
